(19) United States
(12) Patent Application Publication
(10) Pub. No.: US 2013/0302040 A1
(43) Pub. Date: Nov. 14, 2013

(54) OPTICAL-ELECTRICAL CONVERSION MODULE AND OPTICAL TRANSMISSION ASSEMBLY USING THE SAME

(71) Applicant: KUO-FONG TSENG, Tu-Cheng (TW)

(72) Inventor: KUO-FONG TSENG, Tu-Cheng (TW)

(21) Appl. No.: 13/655,519

(22) Filed: Oct. 19, 2012

(30) Foreign Application Priority Data
May 14, 2012 (TW) 101117019

(51) Int. Cl. H04B 10/04; G01J 1/42

(52) U.S. Cl. 398/200; 250/216

(57) ABSTRACT

An optical transmission assembly includes a first optical-electrical conversion module, a second optical-electrical conversion module and a optical waveguide connecting the first and the second optical-electrical conversion modules for transmitting optical signals. The first optical-electrical conversion module and the second optical-electrical conversion module each includes a circuit board, an optical signal emitting member, an optical signal receiving member, and a cover. The optical signal emitting member and the optical signal receiving member are mounted on the circuit board. The circuit board defines a positioning groove. The cover includes a latching portion latching with the positioning groove. The cover defines a latching groove. The optical waveguide includes a inserting portion to latch with the latching groove. The present disclosure further provides an optical-electrical conversion module.

### PRIORITY

This application claims all benefits accruing under 35 U.S.C. §119 from Taiwan Patent Application No. 101117019, filed on May 14, 2012, in the Taiwan Intellectual Property Office, the disclosure of which is incorporated herein by reference.

### BACKGROUND

1. Technical Field

The present disclosure relates to optical-electrical conversion modules, particularly to an optical-electrical conversion module and optical transmission assembly using the optical-electrical conversion module.

2. Description of Related Art

Optical communication is popular. Optical transmitting assemblies for transmitting optical signals include at least one optical-electrical conversion module to convert from electrical signals to optical signals or from optical signals to electrical signals. The optical-electrical conversion module includes a cover fixed on a circuit board by UV-cured glue for covering an optical signal emitting member and an optical signal receiving member. Optical fibers or optical waveguides are connected to the cover, and coupled with the optical-electrical conversion module for transmitting optical signals. The UV glue between the circuit board and the cover may expand when solidified at a high temperature, and may cause shifting of the cover during assembly of the cover to the circuit board. Disassembly of the cover is difficult, thus the cover cannot be easily recycled, but the optical fibers or the optical waveguides may be recycled by cutting off the part connected to the cover. Unable to recycle the cover may result in an increase of cost and a waste of resources.

Therefore, there is room for improvement in the art.

### BRIEF DESCRIPTION OF THE DRAWINGS

The components in the drawing are not necessarily drawn to scale, the emphasis instead being placed upon clearly illustrating the principles of the present disclosure.

FIG. 1 is an isometric view of an embodiment of an optical transmission module.

### DETAILED DESCRIPTION

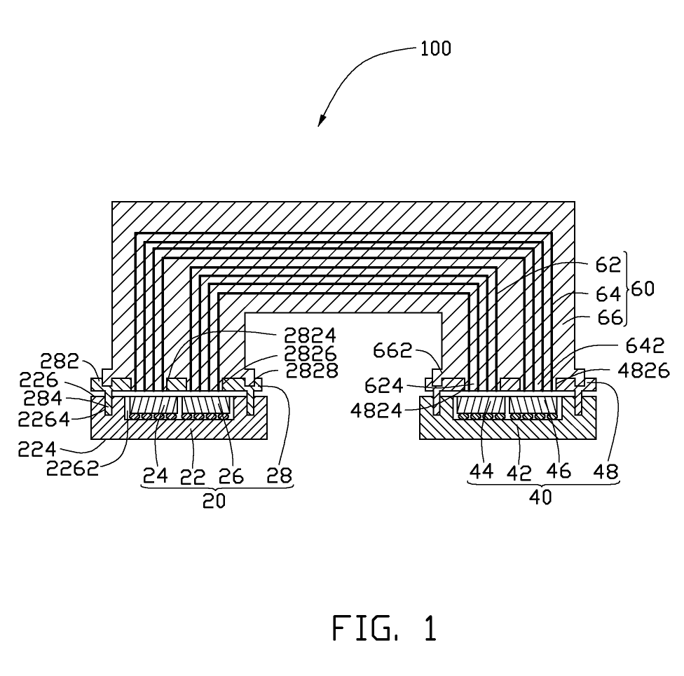

FIG. 1 shows an optical transmission assembly 100 which includes a first optical-electrical conversion module 20, a second optical-electrical conversion module 40, and a optical waveguide 60 connecting the first optical-electrical conversion module 20 to the second optical-electrical conversion module 40. The first optical-electrical conversion module 20 and the second optical-electrical conversion module 40 convert optical signals to electrical signals or convert electrical signals to optical signals. The optical waveguide 60 transmits optical signals between the first optical-electrical conversion module 20 and the second optical-electrical conversion module 40. In the illustrated embodiment, the optical waveguide 60 is a flexible optical waveguide.

The first optical-electrical conversion module 20 includes a circuit board 22, an optical signal emitting member 24, an optical signal receiving member 26, and a cover 28. The optical signal emitting member 24 and the optical signal receiving member 26 are mounted on the circuit board 22 at a distance from each other. The cover 28 latches to the circuit board 22, and is positioned above the optical signal emitting member 24 and the optical signal receiving member 26.

The circuit board 22 includes a bottom surface 224 and a mounting surface 226 opposite to the bottom surface 224. The mounting surface 226 defines a mounting groove 2262 and a pair of positioning grooves 2264 symmetrically positioned at opposite sides of the mounting groove 2262. The mounting groove 2262 is defined at a substantially middle portion of the mounting surface 226. The circuit board 22 may be made of insulating materials, such as resin, glass, or ceramic, for example. A plurality of circuits are arranged on the circuit board, for controlling the optical signal emitting member 24, the optical signal receiving member 26 and other electrical components (not shown) on the circuit board 22 to achieve their functions.

The optical signal emitting member 24 and the optical signal receiving member 26 are received in the mounting groove 2262 spaced from each other, and are electrically connected to the circuits of the circuit board 22. The optical signal emitting member 24 converts electrical signals to optical signals. The optical signal receiving member 26 converts optical signals to electrical signals. In the illustrated embodiment, the optical signal emitting member 24 is a laser diode, and the optical signal receiving member 26 is a photodiode. The optical signal emitting member 24 and the optical signal receiving member 26 are packaged on a bottom surface of the mounting groove 2262 via a plurality of solder balls, and are capable of being re-used. In other embodiment, the optical signal emitting member 24 and the optical signal receiving member 26 may be mounted on the circuit board 22 via conductive adhesive.

The cover 28 includes a main body 282 and a pair of latching portions 284 protruding from two opposite ends of the main body 282. The main body 282 is substantially a plate, and a surface of the main body 282 adjacent to the circuit board 22 defines a first through hole 2824 corresponding to the optical signal emitting member 24, and a second through hole 2826 corresponding to the optical signal receiving member 26. A surface of the main body 282 away from the circuit board 22 defines a pair of latching grooves 2828 at two opposite ends. The latching portions 284 perpendicularly protrude from the surface adjacent to the circuit board 22 outwardly, and latch with the positioning grooves 2264, thus the cover 28 can be connected and latched with the circuit board 22.

In the illustrated embodiment, the second optical-electrical conversion module 40 is substantially same as the first optical-electrical conversion module 20. The second optical-electrical conversion module 40 includes a circuit board 42, an optical signal emitting member 44, an optical signal receiving member 46, and a cover 48. The optical signal emitting member 44 and the optical signal receiving member 46 are mounted on the circuit board 42 spaced from each other. The cover 48 latches to the circuit board 42, and is positioned above the optical signal emitting member 44 and the optical signal receiving member 46. A first through hole 4824 of the cover 48 is defined to correspond to the optical signal emitting member 44, and a second through hole 4826 of the cover 48 is defined to correspond to the optical signal receiving member 46, to enable to the optical waveguide 60 to latch with the cover 48.

The optical waveguide 60 includes a first core 62, a second core 64, and a covering layer 66 covering the first core 62 and second core 64. The first core 62 and the second core 64 are made of same material, and a refractive index of the first core 62 and the second core 64 is higher than a refractive index of the covering layer 66, for total internal reflection of the optical signals in the first core 62 and in the second core 64. The first core 62 is parallel to the second core 64, and both are substantially U-shaped.

Each of two distal ends of the optical waveguide 60 includes a first coupling portion 624 corresponding to first core 62, and a second coupling portion 642 corresponding to the second core 64. The first coupling portion 624 is an outward extension of a distal end of the first core 62 covering the covering layer 66 at a side surface. One of the first coupling portions 624 is inserted into the second through hole 2826 of the first optical-electrical conversion module 20, to enable to the first core 62 to couple with the optical signal receiving member 26. Another one of the first coupling portions 624 is inserted into the first through hole 4824 of the second optical-electrical conversion module 40, to enable the first core 62 to couple with the optical signal emitting member 44. The second coupling portion 642 is an outward extension of a distal end of the second core 64 covering the covering layer 66 at a side surface. The second coupling portions 642 is inserted into the first through hole 2824 of the first optical-electrical conversion module 20, to enable to the second core 64 to couple with the optical signal emitting member 24. Another one of the second coupling portion 642 is inserted into the second through hole 4826 of the second optical-electrical conversion module 40, to enable the second core 64 to couple with the optical signal receiving member 46.

A pair of inserting portions 662 perpendicularly protrude outwards from the distal ends of the covering layer 66 to corresponding with the latching grooves 2828 of the cover 28 or to correspond with the latching grooves of the cover 48. Inserting the pair of inserting portions 662 on one distal end of the covering layer 66 latch with the latching grooves 2828 of the cover 28, and the pair of inserting portions 662 on another distal end of the covering layer 66 latch with the latching grooves of the cover 48, for connecting the optical waveguide to the cover 28 and to the cover 48. In the illustrated embodiment, diameters of the first coupling portions 624, the second coupling portions 642, the first through holes 2824, and the second through holes 2826 are substantially the same, for preventing a loss of optical signals in transmission.

In assembly, first, the first optical-electrical conversion module 20 is assembled. The optical signal emitting member 24 and the optical signal receiving member 26 are mounted on the circuit board 22, and received in the mounting groove 2262. The cover 28 covers the circuit board 22, and the latching portions 284 are inserted into the positioning grooves 2264. Second, the second optical-electrical conversion module 40 is assembled in the same way as the first optical-electrical conversion module 20. Third, the two distal ends of the optical waveguide 60 latch with the cover 28 and with the cover 48. The inserting portions 662 latch with the latching grooves 2828.

In use, the optical signal emitting member 24 receives electrical signals from the circuit board 22, and converts the electrical signals to optical signals, and emits the optical signals to the second coupling portion 642. The optical signals are transmitted to another one of the second coupling portion 642 via the second core 64. The optical signal receiving member 46 receives the optical signals from the second core 64, and converts the optical signals to electrical signals for the circuit board 42. The optical signal emitting member 44 receives electrical signals from the circuit board 42, and converts the electrical signals to optical signals, and emits the optical signals to the first coupling portion 624. The optical signals are transmitted to another one of the first coupling portion 624 via the first core 62. The optical signal receiving member 26 receives the optical signals from the first core 62, and converts the optical signals to electrical signals for the circuit board 22.

In other embodiment, the number of the pair of inserting portions 662 may be one, three, or more, and the number of the pairs of latching grooves 2828 may be one, three, or more according to the pairs of inserting portions 662. The inserting portions 662 and the latching grooves 2828 may be designed in other suitable positions or shapes, such as the inserting portions 662 being posts, and the latching grooves 2828 being holes, for example.

In another embodiment, the pairs of positioning grooves 2264 may be one, three, or more, and the number of the pairs of latching portions 284 may be one, three, or more according to the pairs of positioning grooves 2264. The positioning grooves 2264 and the latching portions 284 may be designed to be other suitable positions or shapes, such as the latching portions 284 being conical posts, and the positioning grooves 2264 being holes which are conical in section, for example.

It is believed that the present embodiments and their advantages will be understood from the foregoing description, and it will be apparent that various changes may be made thereto without departing from the spirit and scope of the embodiments or sacrificing all of its material advantages.

What is claimed is:

1. An optical transmission assembly, comprising:
a pair of optical-electrical conversion modules, and each of the pair of optical-electrical conversion modules comprising a circuit board, an optical signal emitting member, an optical signal receiving member, and a cover, the circuit board defining at least one positioning groove at a surface adjacent to the cover, both the optical signal emitting member and the optical signal receiving member being mounted on the circuit board spaced from each other, the cover defining a pair of through holes at a surface adjacent to the circuit board, the pair of through holes being correspondingly positioned relative to the optical signal emitting member and the optical signal receiving member, and the cover further defining a latching groove at a surface away from the circuit board, and at least one latching portion protruding from the surface of the cover adjacent to the circuit surface, the at least one latching portion being configured to latch with the at least one positioning groove; and
an optical waveguide detachably connecting the pair of optical-electrical conversion modules, the optical waveguide comprising at least one inserting portion protruding from each distal end of the optical waveguide, and the at least one inserting portions is configured to latch with the latching groove of each of the pair of optical-electrical conversion modules.

2. The optical transmission assembly of claim 1, wherein the circuit board defines a mounting groove at the surface adjacent to the cover, the optical signal emitting member and the optical signal receiving member are received in the mounting groove.

3. The optical transmission assembly of claim 2, wherein the optical signal emitting member and the optical signal receiving member are packaged on a bottom surface of the mounting groove via solder balls.

4. The optical transmission assembly of claim 1, wherein the optical waveguide comprises a first core and a covering layer covering the first core.

5. The optical transmission assembly of claim 4, wherein each of two distal ends of the optical waveguide comprises a first coupling portion corresponding to first core; the first coupling portion is an outwardly extension of a distal end of the first core covered by the covering layer at a side surface; one of the first coupling portion is inserted into one of the pair of through holes of a first optical-electrical conversion module of the pair of optical-electrical conversion modules and another one of the first coupling portion is inserted into one through hole of the pair of though holes of a second optical-electrical modules of the pair of optical-electrical conversion modules the first core couples with the optical signal emitting member of one of the pair of optical-electrical conversion modules, and couples with the optical signal receiving member of another one of the pair of optical-electrical conversion modules.

6. The optical transmission assembly of claim 5, wherein the optical waveguide further comprises a second core covered by the covering layer, the second core being parallel to the first core.

7. The optical transmission assembly of claim 6, wherein each of two distal ends of the optical waveguide further comprises a second coupling portion corresponding to the second core; the second coupling portion is an outwardly extension of a distal end of the second core covered by the covering layer at a side surface, one of the second coupling portion is inserted into another one of the pair of through holes of the first optical-electrical conversion module; and another one of the first coupling portion is inserted into another one of the pair of through holes of the second optical-electrical conversion module; the second core couples with the optical signal receiving member of one of the pair of optical-electrical conversion module, and couples with the optical signal emitting member of another one of the pair of optical-electrical conversion modules.

8. The optical transmission assembly of claim 7, wherein a refraction index of the first core and the second core are higher than a refraction index of the covering layer.

9. An optical-electrical conversion module comprising:
a circuit board defining at least one positioning groove,
an optical signal emitting member mounted on the circuit board,
an optical signal receiving member mounted on the circuit board, and
a cover defining a pair of through holes at a surface of the cover adjacent to the circuit board, the pair of through holes being correspondingly positioned relative to the optical signal emitting member and the optical signal receiving member, the cover comprising at least one latching portion protruding from the surface of the cover adjacent to the circuit board, and the at least one latching portion is configured to latch with the at least one positioning groove.

10. The optical-electrical conversion module of claim 9, wherein the circuit board defines a mounting groove at the surface of the circuit board adjacent to the cover, the optical signal emitting member and the optical signal receiving member are received in the mounting groove.

11. The optical transmission assembly of claim 9, wherein the optical signal emitting member and the optical signal receiving member are packaged on a bottom surface of the mounting groove via solder balls.
